(19) United States
(12) Patent Application Publication
(10) Pub. No.: US 2009/0299851 A1
(43) Pub. Date: Dec. 3, 2009

(54) METHOD AND SYSTEM FOR THE MEASUREMENT OF THE IMPACT OF A BILLBOARD ADVERTISEMENT

(75) Inventor: Stephane HEDARCHET, Paris (FR)

Correspondence Address: Carmen Patti Law Group, LLC, One N. LaSalle Street, 44th Floor, Chicago, IL, 60602, US

(73) Assignee: Alcatel-Lucent

(21) Appl. No.: 12/472,970

(22) Filed: May 27, 2009

(30) Foreign Application Priority Data
May 29, 2008 (FR) 0853522

(51) Int. Cl. G06Q 30/00

(52) U.S. Cl. 705/14.45

(57) ABSTRACT

The invention concerns a method for the measurement of the impact of an advertisement concerning a product or service, displayed on at least one advertising billboard (1). According to the method of the invention, the identity of at least one person (4) passing close by the said billboard (1) within a given geographical area (Z1) and during a given period of time, is collected and memorized on the basis of at least one wireless transmission of an identifier contained in at least one portable device (41, 42, 43) likely to be carried by the said person (4). Then, for each memorized identity, any subsequent action out of a predefined list of actions connected to the said product or service and carried out by the said identified person, is collected, and calculation of a global score that is representative of the impact of the said advertisement based on basic predefined scores associated to the said connected actions is then carried out.

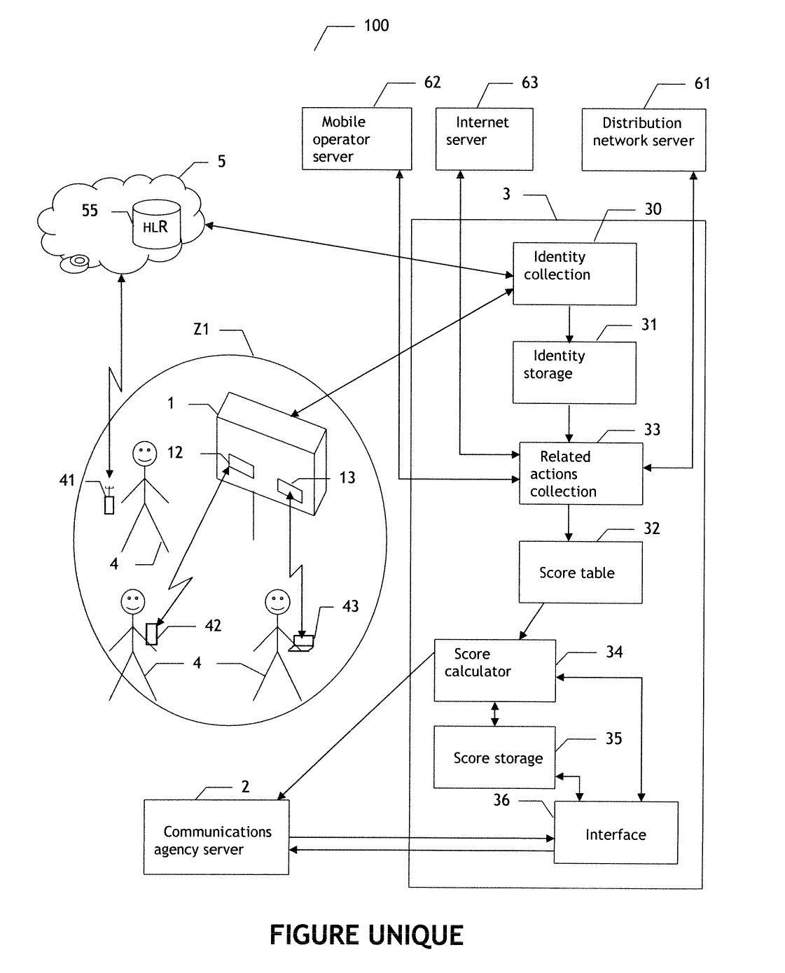

The present invention concerns the domain of advertising display, in particular a method and system for the measurement of the impact of an advertisement concerning a product or service on at least one advertising billboard.

Today's advertising campaigns use numerous disparate means in order to reach as many people as possible. Such different means may, among others, comprise advertising spots broadcast over television or radio programs, inserts in national daily newspapers or local advertising publications, advertising on websites, or leaflets delivered to mailboxes. One of the most traditional methods, however, is advertising billboards set up in geographic areas considered to be of strategic value.

Regardless of the chosen advertising channel, it is important, taking into account the costs associated with an advertising campaign, that communication agencies should be able to know the impact of such campaigns on potential consumers of the product or users of the service.

In the case of advertising billboard posting campaigns, locations are generally chosen as a function of a high level of traffic of persons likely to pass close by such locations. Depending on the subject of the poster, the location may also be chosen depending on the type of area, such as a business district or a residential area. However, such choices are made a priori and it could be of interest to check whether the choice of location is judicious all along the bill posting campaign by regularly measuring the impact of the different locations on potential consumers or users.

The best known method to determine the impact of an advertising bill posting campaign is to submit a questionnaire to a sample of respondents and to develop statistics based on the answers obtained. However, this method has numerous disadvantages. On the one hand, it requires deployment of significant human resources. Indeed, it is necessary to consult teams of experts to develop a pertinent questionnaire, marketing teams—such as operators at call centers—must be set up, or persons must be deployed at high traffic areas to be able to administer the questionnaire to the greatest possible number of people and get the maximum possible amount of answers.

On the other hand, the people thus interviewed are not always correctly targeted or available to answer such questionnaires. Their answers are not always honest, and it is often very difficult to determine the exact cause of a purchase made by a person who is being interviewed. Thus, the analysis of the answers to such questionnaires is not suitable accurately to determine the impact of an advertising bill posting campaign. Furthermore, the organization of such surveys is a lengthy matter because it is necessary to interview a significant number of people, collect the filled in questionnaires, and correlate all answers received. Thus the results are generally obtained well after the bill posting campaign has taken place.

Finally, this type of survey is clearly not appropriate to enable advertising agencies to know whether the locations for dissemination of the advertising have been property chosen.

In parallel or in addition to the traditional method of measurement by survey, telemetry is also used by communications agencies. People having previously agreed to being equipped at their home with a particular device can then actively or passively contribute to the measurement of the impact of advertising spots broadcast over their TV set.

Such devices are suitable for personalizing advertising displays as a function of the television programs viewed by the users equipped with them, or to measure the impact of teleshopping programs. However, they cannot be used to measure the impact of an advertisement disseminated by means of a traditional billboard.

As of today there is therefore not a measurement system making it possible to provide a communications agency with a real time measurement of the impact of a poster as concerns a given location.

The present invention aims at providing greater reactivity and precision to communications agencies by enabling them to verify, in real time and without needing to interview consumers, the impact of their different posters situated at specific locations.

With that objective, a first goal of the invention concerns a method for the measurement of the impact of an advertisement concerning a product or service, displayed on at least one advertising billboard, characterized in that it comprises the following steps:
at a first stage, collection at a server of the identity of at least one person passing close by the said billboard within a given geographical area and during a given period of time, on the basis of at least one wireless transmission of an identifier contained in at least one portable device likely to be carried by the said person, and memorization of such identity;
at a second stage, collection by the said server, for each memorized identity, of any subsequent action carried out by the said identified person from among a predefined list of actions connected to the said product or service, and calculation of a global score that is representative of the impact of the said advertisement based on basic predefined scores associated to the said connected actions.

Preferably, the said connected actions shall comprise an electronic banking transaction, a connection on a website, or a presence in a commercial establishment.

Advantageously, during the stage of collection of the identity of the said person, the moment when the said person passes close by the said advertising billboard is also collected, and, during the stage of collection of the connected action, the moment when the action is carried out is also collected, and the basic score associated to the action is weighted as a function of the time elapsed between the moment when the said person passes close by the said advertising billboard and the moment when the said action is carried out.

A second goal of the invention concerns a system for the measurement of the impact of an advertisement concerning a product or service, displayed on at least one advertising billboard, characterized in that it comprises a server, comprising
first means for the collection of the identity of at least one person passing close by the said billboard within a given geographical area and during a given period of time, on the basis of at least one wireless transmission of an identifier contained in at least one portable device likely to be carried by the said person;
first storage means to store all collected identities;
second storage means to store a predefined list of actions connected to the said product or service;
second collection means, for each identity stored, concerning any subsequent action carried out by the said identified person from among a predefined list of actions connected to the said product or service;
calculation means to calculate a global score that is representative of the impact of the said advertisement based on basic predefined scores associated to the said connected actions.

Advantageously, the billboard shall comprise an RFID reader and/or a WLAN sender/receiver to collect the said identifier and transmit it to the said server over a wired or wireless connection.

Other characteristics and advantages of the invention will become apparent in the description that follows in reference to the single FIGURE attached.

The sole FIGURE schematically represents a preferred architecture of a system for the implementation of a method to measure the impact of an advertisement posted on a billboard 1 according to the invention.

As presented in the sole FIGURE, a system 100 to measure the impact of an advertisement enables a server 2 of a communications agency to recover a representative score of the impact of the said advertisement by contacting a score management server 3.

The server 3 is suitable for regular, e.g. periodic, collection of a first identity information of any person 4 passing close by the billboard 1 within a given geographic area Z1 and a given period of time.

The present invention is based on the hypothesis that, statistically, most people permanently carry on them devices containing an identifier making it possible uniquely to identify them. By way of example but not of limitation, such devices may be mobile telephones, electronic transport passes containing RFID transmitters, or else laptop computers fitted with a WLAN modem. In regard to the abovementioned devices, the module 30 therefore comprises an active radiation RFID sender/receiver and/or a WLAN terminal.

In order to enable identification of the greatest possible number of persons passing close by an advertising billboard, thus rendering measurements more precise and pertinent, the server 3 comprises an identity collection module 30 suitable for the collection of information contained in the different types of portable devices likely to be carried by the relevant individuals.

If the person travels with a mobile telephone 41, the collection module 20 will be able to collect the identity of the person 4 via the cellular telephony network 5.

More particularly, in order to work, a person's mobile phone contains a chip, generally known as a SIM card, which contains a set of identifiers, including the IMSI (International Mobile Subscriber Identity). When it is switched on, the mobile phone 41 constantly exchanges signaling information with components of the cellular telephony network 5 to which it belongs, via base stations. By means of this exchange (via the Cell-Id data), the cellular telephony network 5 knows at all times within which cell the mobile phone 41 is located.

Moreover, the cellular telephony network 5 comprises a correspondence between the telephone and the subscriber's identity within the HLR 55 database. Thus, by combining the information transmitted by the activated mobile phone 41 carried by the person 4 and subscription information, the cellular telephony network knows the identity and position of the person 4 at a given period of time.

In order to take advantage of such knowledge, the cellular identity collection module 30 may periodically query the network 5 so that the latter will supply to it the identities of all persons 4 whose mobile phone 41 was, during a given period of time, close by the billboard 1.

In a preferred embodiment, the cellular identity collection module 30 may request the cellular telephony network 5 regularly to supply to it all identities of the persons present within the cell of the network 5 wherein the billboard 1 is located. The said geographic area Z1 therefore corresponds to the cell of the cellular telephony network 5 wherein the billboard is located.

In the event that it should be desired to identify the person 4 by means of information contained in an RFID badge 42, such as an electronic transport pass, the invention considers equipping the billboard 1 with an RFID reader 12. This type of electronic transport pass generally comprises information such as the rights of use of the transport by the person, the period of utilization and the identity of the holder of the pass. This information can be read by an appropriate RFID reader. Thus the identity of any person 4 passing close by the billboard 1 and bearing such RFID badge 42 will be detected by means of reader 12. The said geographic area Z1 in that case corresponds to the range of the RFID reader 12 on the billboard 4.

The person 4 can also be carrying a device 43 such as a laptop computer equipped with a modem capable of sending and receiving WLAN signals. In that case, the invention considers equipping the billboard 1 with a sender/receiver 13 of WLAN signals in order to be able to collect an identifier of the person 4 during a WLAN transmission performed with the said portable device 43. The said geographic area Z1 can in that case correspond to the range of the WLAN sender/receiver 13 fitted on the billboard 1.

When the identifier is collected by the billboard 1, it must then be transmitted to the identity collection module 30. The transmission takes place by means of any wired or wireless means of communication. The collection module 30 can periodically collect the identifiers stored in the RFID and/or WLAN detector(s) of the billboard 1, or such detectors themselves serve, every time an identifier is collected, to transmit it directly to the collection module 30.

Regardless of the method used to collect the identity of individuals, among the methods explained above used alternatively or in combination, the collected identity is then stored, for example, in storage means or a database 31 of server 3.

The said storage means 31 can be dedicated to the said billboard 1. The said storage means 21 then contains a list of identities of persons having been in the proximity of the said billboard 1 during a given period of time and therefore having seen the advertisement displayed thereon. As a variant, the storage means 31 shall preferably serve to store several lists of identities of persons detected in the proximity of a plurality of billboards 1 broadcasting the same advertisement.

An advertisement is generally considered to be effective if it succeeds in generating a desire or a need in the person having viewed it. Thus a measure of the impact of the advertisement positioned on such billboard 1 can be carried out by detecting a potential change in the behavior of the persons 4 whose identity is contained in the identity storage means 31. In order to measure the impact of the said advertisement positioned on the billboard, the present invention provides for defining a list of actions connected to the product or service, and then for collecting, insofar as possible, all actions connected to the advertisement and performed by the persons on the said list.

Only connected actions, i.e. those actions having a direct link with the product or service shown on the advertisement are to be collected. The link can be direct and can then consist in a transaction such as purchase of the product, or subscription to the service. The link can also be indirect and consist in a request for information about the product or service via a connection to a website, or travel by the person to a place likely to expose, sell, or contain information on the said product or service.

The present invention is based on the ascertained fact that most connected actions require the person performing them to identify himself or herself. Indeed, in many cases,
a person will settle a transaction by means of an electronic payment method such as a payment card containing the person's identity;
a request for information will take place via a website requiring authentication;
travel to a specialized location will be detected in particular via entry/exit control terminals suitable to collect the identity of visitors.

For each advertisement displayed, the server 3 has storage means 32 referred to as a score table, comprising a list of connected actions likely to be carried out by the persons 4 having seen the advertising poster. The said list can advantageously be supplemented by the communications agency every time there is a modification to the advertisement on billboard 1.

To determine the performance of such actions by a person 4 having passed close by the said billboard 1, the server 3 comprises means for the collection of any connected action carried out by the said person subsequently to the collection of the said person's identity via the identity collection means 30.

More specifically, the list of identities contained in the storage means 31 can be regularly transmitted to the action collection means 33. For each identity contained in the list, the action collection means 31 are adapted to detect performance by the identified person of all the actions contained in the list of connected actions stored in the score table 32.

As previously mentioned, the connected actions may be of several types. Thus, when the said connected action carried out by the said identified person is a transaction for purchase of the product or subscription to the service, the said connected action is collected when an electronic payment is made. Electronic banking payments can be carried out by means of a payment card in a store, in which case the action collection means 33 are suitable to collect the transactions carried out on a management server 61 of a store identifying, among other things, all transactions taking place at the store. Electronic banking payments can also be carried out by means of a mobile terminal such as a GPRS terminal, in which case the action collection means 33 are suitable to collect the transactions carried out on a management server 62 of a mobile telephony operator.

The said connected action can also be a connection to a website related to the product or service displayed in the advertisement. In such cases, collection of the action can take place via the collection of a history of user connections having accessed the website at a given moment in time. The action collection means 33 are then adapted to collect such history data present on Internet servers 63.

In parallel, or in addition to a transaction or a request for information on a website, the person can also go to a store, a tourist office, or an agency to request information or simply in order more accurately to apprehend the product or service presented by the advertisement. In such cases, collection of the action can take place via the collection of a history of entering/exiting actions concerning the store, tourist office, or agency. Advantageously, detection of entering/exiting actions can be performed at such locations by means of presence terminals suitable for collection of the identifier of the device likely to be carried by the said person. The action collection means 33 are then adapted to collect such history data present on store management servers 61.

When the collection means 33 collect a connected action for an identity contained in the identity storage means 21, they transmit the said action to calculation means 34 that calculate a global score that is representative of the impact of the said advertisement.

More specifically, each connected action contained in the score table 32 is assigned a basic score by the communications agency. The said basic score enables classification of the connected actions. For example, purchase of the product or subscription to the service presented in the advertisement will translate a strong impact of the advertisement on the person 4 having viewed it. Such connected action shall therefore have a high associated basic score. On the contrary, a simple request for information on the product or service can mean that the person 4 has indeed been influenced by the advertisement but that it was not entirely convincing; in that case the impact on the person 4 has indeed taken place but has not been determining. A low basic score is therefore assigned to such action.

When the advertisement has just been affixed to the billboard, the global score that is representative of the impact of the said advertisement is set to zero. Each time the action collection means 33 transmit a connected action to the calculation means 34, the latter increase the global score of the basic score associated to the connected action collected. The global score is then continually updated in real time until the end of the bill posting campaign.

In a preferred embodiment, the basic score associated to the action is weighted as a function of the time elapsed between the moment when the person 4 has passed through the geographic area Z1 in the proximity of the billboard and the moment when the action is performed. The said weighting can refine the measurement in the sense that it can provide an indication concerning the force of the impact of the advertisement on the person 4 having viewed it. Indeed, if the person buys the product soon after having seen the advertisement, it can be considered that the advertisement has very strongly influenced the behavior of the said person 4.

In order to be able to implement weighting of this kind,
the identity collection means 30 are also suitable to collect the moment when the person 4 passes close by the said advertising billboard 1;
the action collection means 33 are suitable to collect the moment when the connected action is performed;
the calculation means 34 are suitable to compute the difference between the two moments in order to determine the time elapsed between the transit close by the billboard and the performance of the action.

Advantageously, the server 2 can, in storage means 35, store the results of measurements effected on the same billboard 1 for advertisements concerning the same product or service in respect to a prior bill posting campaign. Such prior impact measures can be used as weighting for the global score. Such weighting will enable communications agencies to take into account the subsisting effect of any potential prior bill posting campaigns on persons 3.

As a variant or in combination, the global score can also be weighted based on statistical laws or extrapolations performed based on statistical analysis methods and/or extrapolation means contained in the score storage means 35. These different means of statistical analysis and/or extrapolation, known to a person skilled in the art, will enable the result obtained based on the basic scores to be refined, in particular in those cases where few people have transited before the billboard 1.

Each time the global score is updated, the server 3 is adapted to transmit the new global score to the communications agency supervising the bill posting campaign. Such transmission will enable the communications agency to adapt dissemination of the advertisement on billboards all throughout the campaign or more rapidly to order a new advertisement if the results of the impact measurements are disappointing.

In a preferred embodiment, the communications agency can, by means of an interface 36 available on the server 3, check the global score for a particular period of the bill posting campaign or the global score of an old bill posting campaign. These options enable easy comparison of the impact of several sequential campaigns on the same billboard.

Although the different characteristics and advantages of the invention have been described by reference to a measurement system comprising only one billboard, the invention is not limited to a system of this kind. The invention can also be implemented in a system comprising a plurality of billboards showing the first advertisement, or else different advertisements.

1. Method for the measurement of the impact of an advertisement concerning a product or service, displayed on at least one advertising billboard (1), characterized in that it comprises the following steps:
at a first stage, collection of the identity of at least one person (4) passing close by the said billboard (1) within a given geographical area (Z1) and during a given period of time, on the basis of at least one wireless transmission of an identifier contained in at least one portable device (41, 42, 43) likely to be carried by the said person (4), and memorization of such identity;
at a second stage, collection, for each memorized identity, of any subsequent action carried out by the said identified person, from among a predefined list of actions connected to the said product or service, and calculation of a global score that is representative of the impact of the said advertisement based on basic predefined scores associated to the said connected actions.

2. Method according to claim 1, characterized in that, the said portable device being a mobile phone (41) enabling access to a cellular communication network (5), the said identifier is collected via the said cellular communication network (5).

3. Method according to claim 1, characterized in that, the said portable device being equipped with a WLAN modem (43), or with an RFID sender (42), the said identifier is collected via a wireless transmission to the said billboard (1).

4. Method according to claim 1, characterized in that the connected actions comprise an electronic banking transaction, a connection on a website, or a presence in a commercial establishment.

5. Method according to claim 4, characterized in that, the said connected action that is performed being a connection on a website, such connected action is collected via a history of user connections on the said site.

6. Method according to claim 4, characterized in that, the said connected action that is performed being a presence in a commercial establishment, such connected action is collected via a detection system of the said portable device likely to be carried by the said person (4) in the said commercial establishment.

7. Method according to claim 1, characterized in that, during the stage of collection of the identity of the said person (4), the moment when the said person (4) passes close by the said advertising billboard (1) is also collected; in that, during the stage of collection of the connected action, the moment when the action is carried out is also collected; and in that the basic score associated to the action is weighted as a function of the time elapsed between the moment of transit of the said person (4) and the moment when the said action is carried out.

8. Method according to claim 1, characterized in that the global score is, in addition, a function of statistical laws and/or extrapolations performed based on statistical analysis means and/or extrapolation means.

9. System for the measurement of the impact of an advertisement concerning a product or service, displayed on at least one advertising billboard (4), characterized in that it comprises a server (3), comprising
first means (30) for the collection of the identity of at least one person (4) passing close by the said billboard (1) within a given geographical area (Z1) and during a given period of time, on the basis of at least one wireless transmission of an identifier contained in at least one portable device (41, 42, 43) likely to be carried by the said person (4);
first storage means (31) to store all collected identities;
second storage means (32) to store a predefined list of actions connected to the said product or service;
second collection means (33), for each identity stored, concerning any subsequent action carried out by the said identified person from among a predefined list of actions connected to the said product or service;
calculation means (34) to calculate a global score that is representative of the impact of the said advertisement based on elementary predefined scores associated to the said connected actions.

10. System according to claim 9, characterized in that the billboard (1) comprises an RFID reader (12) and/or a WLAN sender/receiver (13) to collect the said identifier, and in that the said RFID reader and the said WLAN sender/receiver transmit the said identifier to the said server (3) over a wired or wireless connection.

11. System according to claim 9, characterized in that the means (30) for the collection of the identity of a person are suitable to collect data stored in a device (5) pertaining to a cellular communication network or to collect billboard (1) stored data.

12. System according to claim 9, characterized in that the means (33) for the collection of an action are suitable to collect data stored in at least one device (61, 62, 63) that is external to the server (3) such as, in particular, a server (62) pertaining to a telephony operator, a web server (63), or a store or distribution chain management server (61).
